(19) United States
(12) Patent Application Publication
(10) Pub. No.: US 2026/0208985 A1
(43) Pub. Date: Jul. 23, 2026

(54) PASSING MECHANISM

(71) Applicant: TOYOTA JIDOSHA KABUSHIKI KAISHA, Toyota-shi, Aichi-ken (JP)

(72) Inventors: Masatomo IWAKI, Toyota-shi (JP); Takeshi MATSUI, Nisshin-shi (JP); Shiro ODA, Anjo-shi (JP)

(73) Assignee: TOYOTA JIDOSHA KABUSHIKI KAISHA, Toyota-shi, Aichi-ken (JP)

(21) Appl. No.: 19/135,927

(22) PCT Filed: Dec. 8, 2023
(86) PCT No.: PCT/IB2023/062399

§ 371 Date: Jun. 5, 2025

(30) Foreign Application Priority Data
Dec. 22, 2022 (JP) 2022-205329

(51) Int. Cl. B65G 67/02; B65G 1/04

(52) U.S. Cl. CPC B65G 67/02; B65G 1/04

(57) ABSTRACT

A passing mechanism includes an installed shelf for placing a package, and a mobile body including a mobile body-side stage. The mobile body-side stage is included in the mobile body for placing the package, wherein the mobile body is configured to pass through the installed shelf such that the package is passed between the installed shelf and the mobile body.

### BACKGROUND OF THE INVENTION

### 1. Field of the Invention

The present disclosure relates to a package passing mechanism.

### 2. Description of Related Art

Japanese Unexamined Patent Application Publication (Translation of PCT Application) No. 2020-508274 (JP 2020-508274 A) discloses a robot including a containing apparatus that contains items. This robot includes an item grabbing apparatus for grabbing an item. The item grabbing apparatus grabs an item from an item storage apparatus and places it in the containing apparatus. The item grabbing apparatus also grabs an item from the containing apparatus and places it in the item storage apparatus.

### SUMMARY OF THE INVENTION

In JP 2020-508274 A, there is a problem that a package cannot be passed efficiently. When transporting a package by a mobile body such as a robot, it is desirable to efficiently transfer (load or unload) an item (package). Transport efficiency can be increased by simply transferring the package.

A passing mechanism according to a first aspect of the present disclosure includes an installed shelf for placing a package; and a mobile body including a mobile body-side stage, the mobile body-side stage being included in the mobile body for placing the package, wherein the mobile body is configured to pass through the installed shelf such that the package is passed between the installed shelf and the mobile body.

In the passing mechanism, the installed shelf may include a first stage and a second stage having a height different from a height of the first stage.

In the passing mechanism, the mobile body may be configured to pass through the installed shelf such that a first package on the first stage is passed to the mobile body-side stage and a second package on the mobile body-side stage is passed to the second stage.

In the passing mechanism, the installed shelf may include a first abutment portion configured to abut on a mechanism in the mobile body when the mobile body moves, and the mobile body may include a second abutment portion configured to abut on a mechanism in the installed shelf when the mobile body moves.

In the passing mechanism, the second abutment portion may be configured to push the first package on the first stage in a moving direction of the mobile body such that the first package is passed to the mobile body-side stage; and the first abutment portion may be configured to push the second package on the mobile body-side stage in a direction opposite to the moving direction such that the second package is passed to the second stage.

In the passing mechanism, the second abutment portion may be provided at a position higher than a position of the second package and at a height of the first package.

In the passing mechanism, at least one of the first abutment portion and the second abutment portion may include a locking member configured to lock the package.

In the passing mechanism, at least one of the first abutment portion and the second abutment portion may include an elastic body configured to absorb energy at a time of abutment.

In the passing mechanism, at least one of the first abutment portion and the second abutment portion may include a cord-shaped or band-shaped flexible body configured to absorb energy at a time of abutment.

In the passing mechanism, at least one of the first abutment portion and the second abutment portion may include a hook configured to hook the package.

In the passing mechanism, the mobile body-side stage may be configured to pass at a height between the first stage and the second stage.

In the passing mechanism, the first stage may be installed at a position higher than a position of the second stage, and a first abutment portion on the first stage may be provided at a height of the second package.

In the passing mechanism, at least one of the installed shelf and the mobile body-side stage may include a magnet configured to magnetically attract the package; and a switching operation for switching ON and OFF of magnetic attraction of the magnet may be performed when the mobile body passes through the installed shelf.

The passing mechanism may further include a sensor configured to detect passage of the mobile body, wherein the switching operation may be performed based on a detection result from the sensor.

According to the present disclosure, it is possible to provide the passing mechanism capable of efficiently passing packages.

### BRIEF DESCRIPTION OF THE DRAWINGS

Features, advantages, and technical and industrial significance of exemplary embodiments of the invention will be described below with reference to the accompanying drawings, in which like signs denote like elements, and wherein:

FIG. 1 is a perspective view showing an overall configuration of a transport robot according to an embodiment;

FIG. 2 is a perspective view showing the configuration of the transport robot that is transporting a wagon;

FIG. 3 is a top view illustrating a passing mechanism;

FIG. 4 is a side view illustrating the passing mechanism;

FIG. 5 is a schematic diagram illustrating a passing operation;

FIG. 6 is a schematic diagram illustrating the passing operation;

FIG. 7 is a schematic diagram illustrating the passing operation;

FIG. 8 is a schematic diagram illustrating the passing operation;

FIG. 9 is a schematic diagram illustrating the passing operation;

FIG. 10 is a schematic diagram illustrating the passing operation;

FIG. 11 is a side view showing a configuration in which a plurality of packages is placed on a rack;

FIG. 12 is a flowchart showing a passing operation of a second embodiment;

FIG. 13 is a side view showing the configuration of one example of a sensor;

FIG. 14 is a side view showing the configuration of one example of the sensor;

FIG. 15 is a top view showing the configuration of one example of the sensor;

FIG. 16 is a schematic diagram illustrating the passing operation of the second embodiment;

FIG. 17 is a schematic diagram illustrating the passing operation of the second embodiment;

FIG. 18 is a schematic diagram illustrating the passing operation of the second embodiment;

FIG. 19 is a schematic diagram illustrating the passing operation of the second embodiment;

FIG. 20 is a schematic diagram illustrating a passing operation of a third embodiment;

FIG. 21 is a schematic diagram illustrating the passing operation of the third embodiment;

FIG. 22 is a schematic diagram illustrating the passing operation of the third embodiment;

FIG. 23 is a schematic diagram illustrating the passing operation of the third embodiment;

FIG. 24 is a schematic diagram illustrating a passing operation of a fourth embodiment;

FIG. 25 is a schematic diagram illustrating the passing operation of the fourth embodiment;

FIG. 26 is a schematic diagram illustrating the passing operation of the fourth embodiment;

FIG. 27 is a schematic diagram illustrating the passing operation of the fourth embodiment;

FIG. 28 is a schematic diagram illustrating an operation for opening and closing wall portions 251;

FIG. 29 is a top view illustrating the configuration of an abutment portion according to a fifth embodiment;

FIG. 30 is a schematic diagram illustrating a passing operation of the fifth embodiment;

FIG. 31 is a schematic diagram illustrating the passing operation of the fifth embodiment;

FIG. 32 is a schematic diagram illustrating the passing operation of the fifth embodiment; and FIG. 33 is a schematic diagram illustrating the passing operation of the fifth embodiment.

### DETAILED DESCRIPTION OF EMBODIMENTS

Hereinafter, the present invention will be described through embodiments of the invention. However, the invention according to the claims is not limited to the following embodiments. All the configurations described in the embodiments are not necessarily essential as means for solving the problem.

### First Embodiment

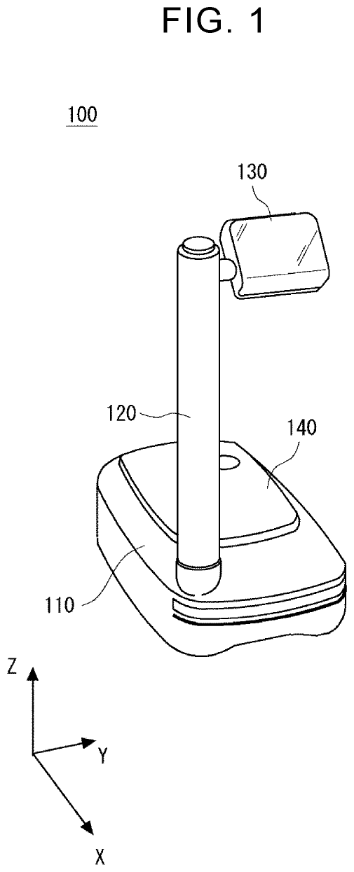

FIG. 1 is a perspective view showing an overall configuration of a transport robot 100 according to the present embodiment. In the following description, an XYZ orthogonal coordinate system will be used as appropriate. An X direction is a front-rear direction of the transport robot 100, a Y direction is a right-left direction, and a Z direction is a vertical up-down direction. More specifically, a +X direction is defined as a forward direction of the transport robot 100, and a −X direction is defined as a rearward direction of the transport robot 100. A +Y direction is a leftward direction of the transport robot 100, and a −Y direction is a rightward direction of the transport robot 100. A +Z direction is a vertically upward direction, and a −Z direction is a vertically downward direction.

The transport robot 100 can move both in the forward direction and in the rearward direction. That is, the transport robot 100 moves in the forward direction by forward rotation of wheels, and moves in the rearward direction by reverse rotation of the wheels. By changing the rotation speeds of the right and left wheels, the transport robot 100 can turn right or left.

The transport robot 100 includes a chassis 110, a stand 120, and an operation unit 130. Wheels, axles, a battery, a control computer, a drive motor, and the like are mounted on the chassis 110. The chassis 110 rotatably holds the wheels (not shown in FIG. 1). The chassis 110 may be provided with various sensors such as a camera and a ranging sensor. Description will be made assuming that the transport robot 100 is an autonomous mobile robot. The transport robot 100 may be a mobile robot that moves in response to user operations.

The chassis 110 houses a lift mechanism 140 for loading and unloading packages. The lift mechanism 140 is disposed on the upper face side of the chassis 110. The lift mechanism 140 is a lift stage capable of ascending and descending. The chassis 110 is provided with a lift motor and a guide mechanism. An upper face of the lift mechanism 140 serves as a placement face where a wagon is placed. The lift mechanism 140 includes a lifting mechanism for lifting the wagon. A space above the lift mechanism 140 serves as a loading space where packages are loaded.

The stand 120 is attached to the chassis 110. The stand 120 is a rod-shaped member extending upward from the chassis 110. The stand 120 has a columnar shape with its longitudinal direction corresponding to the Z direction. The longitudinal direction of the stand 120 is parallel to the Z direction. The stand 120 is disposed outside the lift mechanism 140. That is, the stand 120 is disposed so as not to interfere with lifting operations of the lift mechanism 140. The stand 120 is disposed on one end side of the chassis 110 in the Y direction (right-left direction). The stand 120 is attached near the right front corner of the chassis 110. The stand 120 is provided at the end of the chassis 110 on a +X side and a −Y side on an XY plane.

The stand 120 supports the operation unit 130. The operation unit 130 is attached near an upper end of the stand 120. Thus, the operation unit 130 can be installed at a height at which a user can easily operate. That is, the stand 120 extends to a height at which the standing user can easily operate. The operation unit 130 extends to a +Y side from the stand 120. The operation unit 130 is disposed at the middle of the chassis 110 in the right-left direction.

The operation unit 130 includes a touch panel monitor or the like that receives user operations. The operation unit 130 may include a microphone or the like for audio input. The monitor of the operation unit 130 is oriented opposite to the chassis 110. That is, a display face (operation face) of the operation unit 130 is a face on the +X side. The operation unit 130 may be detachable from the stand 120. That is, a holder that holds the touch panel may be attached to the stand 120. The user can input, for example, transport destinations of packages and transport information about the packages by operating the operation unit 130. The operation unit 130 can display, for the user, information such as details of packages being transported and packages to be transported, and destinations of the packages.

The user stores a package (also referred to as “item” or “transport target object”) in the wagon placed on the transport robot 100, and requests transport. The transport robot 100 transports the package by autonomously moving to a set destination. That is, the transport robot 100 executes a package transport task (hereinafter also referred to simply as “task”). In the following description, a location at which the package is loaded will also be referred to as “transport origin” or “loading location”, and a location to which the package is delivered will also be referred to as “transport destination” or “destination”.

In one exemplary assumption, the transport robot 100 moves within a general hospital that has a plurality of clinical departments. The transport robot 100 transports equipment, consumables, medical instruments, and the like among the clinical departments. For example, the transport robot 100 delivers a package from a nurses'station of one clinical department to a nurses'station of another clinical department. Alternatively, the transport robot 100 delivers a package from a storeroom for equipment and medical instruments to a nurses'station of a clinical department. The transport robot 100 also delivers medicines dispensed at a pharmaceutical department to a clinical department or patients scheduled to use the medicines.

Examples of the package include medicines, consumables such as bandages, specimens, testing instruments, medical instruments, hospital food, and equipment such as stationery. Examples of the medical instruments include sphygmomanometers, blood transfusion pumps, syringe pumps, foot pumps, nurse call buttons, bed leaving sensors, low-pressure continuous inhalers, electrocardiogram monitors, drug injection controllers, enteral nutrition pumps, artificial respirators, cuff pressure gauges, touch sensors, aspirators, nebulizers, pulse oximeters, artificial resuscitators, aseptic devices, and echo machines. Meals such as hospital food and examination meals may be transported. The transport robot 100 may transport used equipment, used tableware after meals, and the like. When the transport destination is on a different floor, the transport robot 100 may move by using an elevator or the like.

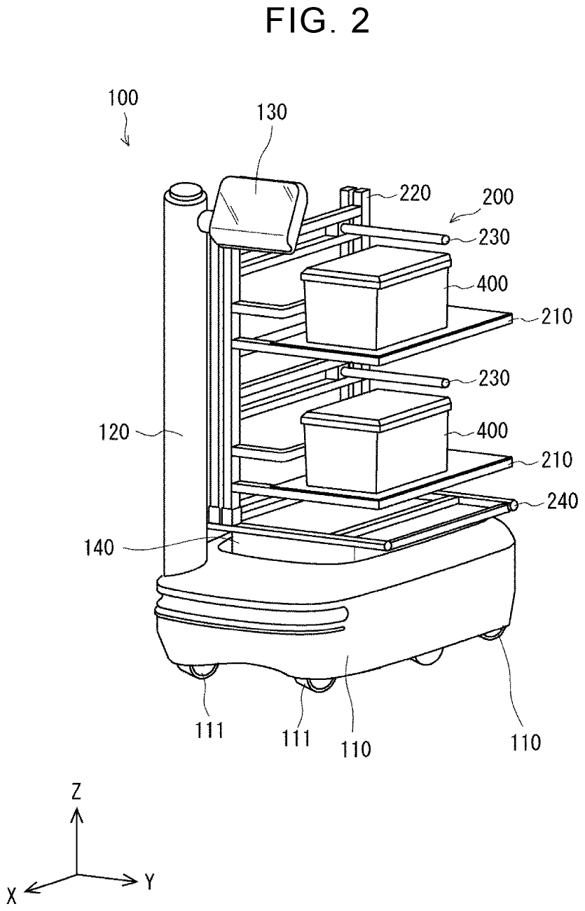

Next, a configuration for mounting shelves on the transport robot 100 will be described with reference to FIG. 2. As shown in FIG. 2, a shelf portion 200 is provided above the chassis 110. The shelf portion 200 is attached to the chassis 110. Accordingly, the chassis 110 supports the shelf portion 200. The shelf portion 200 includes racks 210, a frame 220, and a base plate 240. As described later, the transport robot 100 can transfer packages to and from an installed shelf by passing through the installed shelf. That is, the transport robot 100 can receive a package on the installed shelf by passing through the installed shelf. Alternatively, the transport robot 100 can transfer a package on the shelf portion 200 to the installed shelf by passing through the installed shelf.

The rack 210 is a plate-shaped member provided along the XY plane. In FIG. 2, the shelf portion 200 includes two racks 210. Packages 400 are placed on the racks 210. That is, the racks 210 support the packages 400. The two racks 210 are disposed at different heights. The packages 400 are placed on the two respective racks 210. That is, the two racks 210 are spaced away from each other in the Z direction by the height of the package 400 or more. The shelf portion 200 serves as a mobile body-side stage on which a package is placed.

Although the shelf portion 200 includes the two racks 210 in FIG. 2, the number of racks 210 is not particularly limited. The number of racks 210 may be one, three, or more. The racks 210 are disposed directly above the chassis 110. That is, the racks 210 are laid on the chassis 110 in XY plan view. The racks 210 are disposed above the lift mechanism 140.

The base plate 240 is a plate-shaped member provided along the XY plane. The base plate 240 is attached to the upper face of the lift mechanism 140. The base plate 240 is disposed on a −X side of the stand 120. The base plate 240 may be fixed to the chassis 110 by using fixing means such as bolts.

The frame 220 is attached to the base plate 240. The base plate 240 supports the frame 220. The frame 220 is attached to the base plate 240 at the end of the base plate 240 on the −Y side. The frame 220 extends upward from the base plate 240. That is, the frame 220 is disposed above the right end of the chassis 110. The frame 220 is disposed on the −X side of the stand 120.

The frame 220 supports the racks 210. The frame 220 is attached to the chassis 110 on the outer side of the lift mechanism 140. The frame 220 extends upward on the outer side of the lift mechanism 140. The racks 210 extend to the +Y side from the frame 220. That is, the racks 210 are provided to protrude to the +Y side from the frame 220. The racks 210 have approximately the same size as the chassis 110 on the XY plane.

The shelf portion 200 passes the packages 400 to and from the installed shelf. The installed shelf is provided in a facility in which the transport robot 100 is used. The packages placed on the installed shelf are transferred to the shelf portion 200. The packages 400 placed on the shelf portion 200 are transferred to the installed shelf. The frame 220 includes abutment portions 230 for passing the packages 500. For example, the abutment portion 230 is a rod-shaped member extending in the +Y direction. Alternatively, the abutment portion 230 may have a hook shape for engagement with a package 500. The abutment portion 230 will be described later.

When the transport robot 100 passes through the installed shelf, the packages 400 are passed. The packages 400, 500 can be passed between the shelf portion 200 and the installed shelf without using a transport actuator. That is, there is no need to provide the installed shelf or the transport robot with a transfer robot arm. By attaching the shelf portion 200, the packages can be loaded and unloaded simply and quickly.

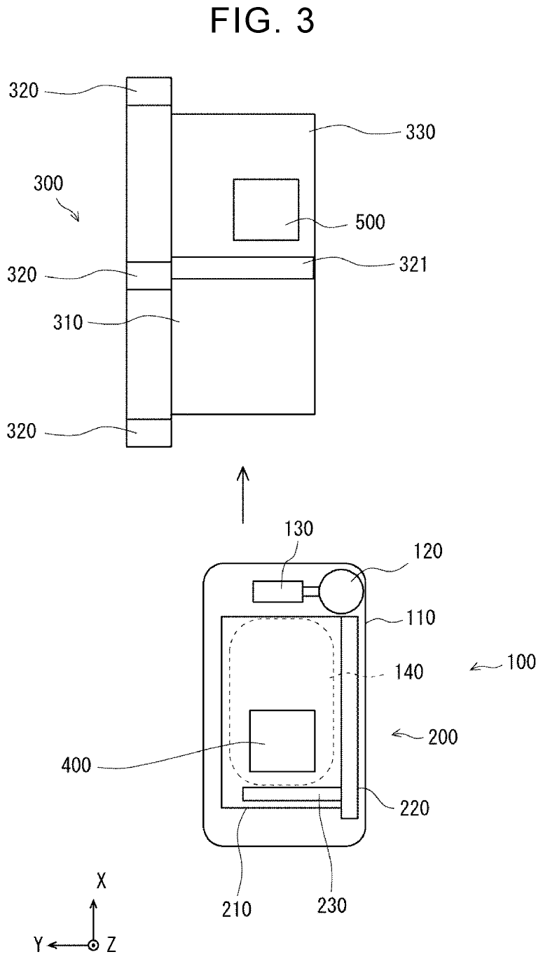

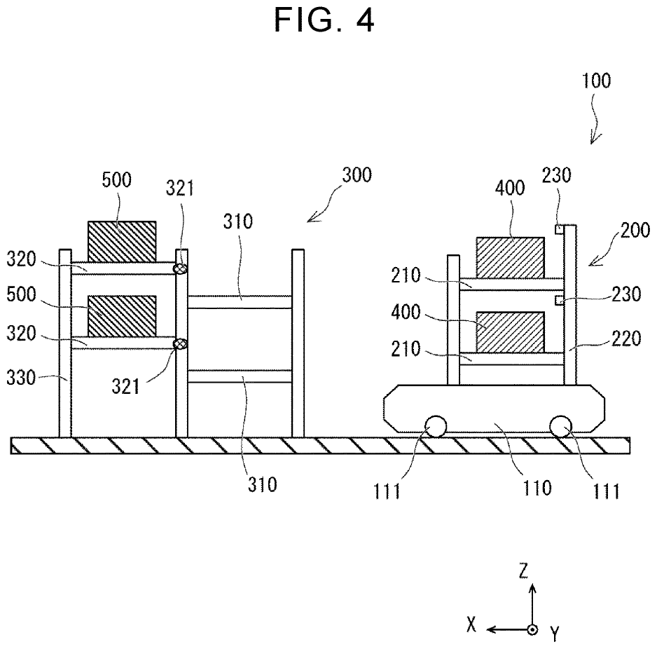

The configurations of the transport robot 100 and the installed shelf will be described with reference to FIGS. 3 and 4. FIG. 3 is a top view schematically showing the configurations of an installed shelf 300 and the transport robot 100. FIG. 4 is a sectional side view schematically showing the configurations of the installed shelf 300 and the transport robot 100. FIGS. 3 and 4 show the configurations before packages are passed. That is, the transport robot 100 moves in the +X direction in the state shown in FIGS. 3 and 4 to approach the installed shelf 300. When the transport robot 100 passes through the installed shelf 300, the packages are passed.

The installed shelf 300 is a fixed shelf that is fixed to a storage, a passage, or the like. The packages 500 are placed on the installed shelf 300. The transport robot 100 includes the shelf portion 200. The rack 210 of the shelf portion 200 mounted on the transport robot 100 can be regarded as “movement-side stage”.

When the transport robot 100 passes through the installed shelf 300, the packages 500 are transferred from the installed shelf 300 to the shelf portion 200 and the packages 400 are transferred from the shelf portion 200 to the installed shelf 300. That is, when the transport robot 100 passes through the installed shelf 300, the packages 400, 500 are passed between the installed shelf 300 and the shelf portion 200. Since the transport robot 100 can perform the transfer of the packages 400 and the transfer of the packages 500 substantially simultaneously, the packages can be reloaded efficiently. Although the packages 400, 500 are described as rectangular parallelepiped boxes, the shapes of packages 400, 500 are not particularly limited.

The installed shelf 300 includes first racks 310, a frame 330, and second racks 320. The first rack 310 serves as a first stage to which the package 400 is transferred. The second rack 320 serves as a second stage on which the package 500 is placed. Before the transfer, the first rack 310 is an empty rack on which no package 500 is placed. When the transfer is completed, the package 500 is placed on the rack 210 and the package 400 is placed on the first rack 310. After the completion of the transfer, the second rack 320 is an empty rack on which no package 500 is placed. Although the first rack 310 and the second rack 320 are flat plates parallel to the XY plane, they may have a chute structure inclined along the Y direction.

The first racks 310 are formed in two upper and lower stages similarly to the racks 210. The second racks 320 are also formed in two upper and lower stages similarly to the racks 210. The package 400 on the upper rack 210 is transferred to the upper first rack 310. The package 500 on the upper second rack 320 is transferred to the upper rack 210. The following description will be made about the configuration of the same stage out of the two stages of the racks. For example, only the upper racks will be described, and description of the lower racks will be omitted.

The first rack 310 is disposed on the −X side of the second rack 320. The first rack 310, the second rack 320, and the rack 210 have different heights. Specifically, the first rack 310 is installed lower than the rack 210, and the second rack 320 is installed higher than the rack 210. The heights of the first rack 310, the second rack 320, and the rack 210 do not change even when the transport robot 100 moves.

As the transport robot 100 moves, the rack 210 passes at a height between the first rack 310 and the second rack 320. Specifically, the package 400 on the rack 210 is transferred to the first rack 310 when the transport robot 100 passes. Therefore, the upper face (placement face) of the first rack 310 is below the lower face of the package 400. The package 500 on the second rack 320 is transferred to the rack 210 when the transport robot 100 passes. Therefore, the upper face (placement face) of the rack 210 is below the lower face of the package 500.

When the transport robot 100 moves in the +X direction, the package 400 on the rack 210 is first transferred to the first rack 310. Thus, a space for placing the package 500 is secured on the rack 210. Passing of the package 400 from the shelf portion 200 to the installed shelf 300 is completed. When the transport robot 100 further moves in the +X direction, the package 500 on the second rack 320 is transferred to the rack 210. Passing of the package 500 from the installed shelf 300 to the shelf portion 200 is completed.

The installed shelf 300 includes an abutment portion 321. The abutment portion 321 is disposed at a position higher than that of the rack 210. Specifically, the abutment portion 321 is provided at the height of the package 400. As described later, the abutment portion 321 abuts on the package 400 to push the package 400 onto the first rack 310. The abutment portion 321 is herein provided at the height of the second rack 320. For example, the abutment portion 321 is provided at the end of the second rack 320 on the −X side. The abutment portion 321 is a rod-shaped member extending from the frame 330 in the −Y direction. Alternatively, the abutment portion 321 may have a hook shape for engagement with the package 400. Alternatively, the end face of the second rack 320 may serve as the abutment portion 321.

Movement of the package 400 is restricted by the abutment portion 321 abutting on the package 400. That is, the abutment portion 321 holds the package 400 so that the package 400 does not move along with the movement of the transport robot 100. Therefore, the abutment portion 321 can push the package 400 from the rack 210 in the −X direction. The package 400 is transferred from the rack 210 to the first rack 310.

The shelf portion 200 includes the abutment portion 230. The abutment portion 230 is disposed at a position higher than those of the second rack 320 and the package 400. Specifically, the abutment portion 230 is provided at the height of the package 500. As described later, the abutment portion 230 abuts on the package 500 to push the package 500 onto the rack 210. The abutment portion 230 is disposed on the −X side of the package 400. In the X direction, the abutment portion 230 is disposed near the end of the rack 210 on the −X side. The abutment portion 230 is attached to the frame 220. For example, the abutment portion 230 is a member extending from the frame in the +Y direction.

When the abutment portion 230 abuts on the package 500, the package 500 moves in the +X direction along with the movement of the transport robot 100. That is, the abutment portion 230 can push the package 500 from the second rack 320 in the positive direction. The package 500 is transferred from the second rack 320 to the rack 210.

The frame 330 and the like are disposed at positions where they do not interfere with the shelf portion 200. Similarly, the stand 120, the frame 220, and the like are disposed at positions where they do not interfere with the installed shelf 300.

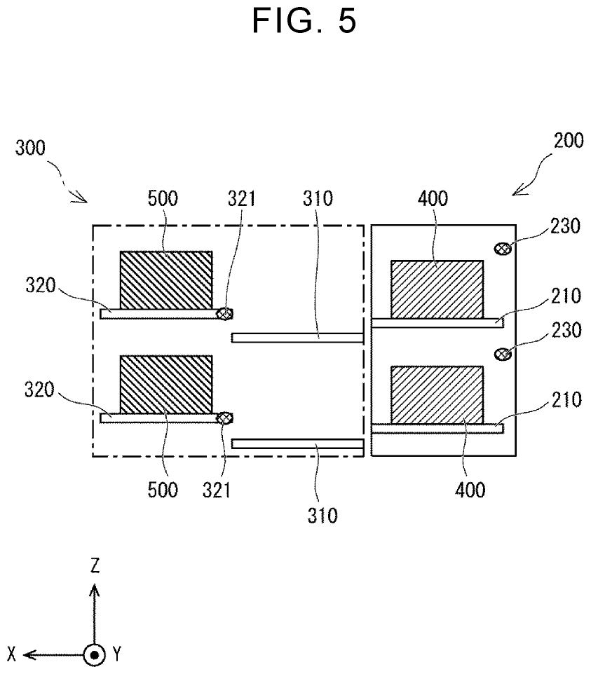

Next, a package passing operation will be described in detail with reference to FIGS. 5 to 10. FIGS. 5 to 10 are side views illustrating steps of the passing operation. FIGS. 5 to 10 simply show a part of the configuration shown in FIGS. 1 to 4. For example, the transport robot 100, the frame 220, and the frame 330 are omitted in FIGS. 5 to 10.

FIG. 5 shows a configuration before the packages 400, 500 are transferred. That is, the package 400 is placed on the rack 210 of the shelf portion 200, and the package 500 is placed on the second rack 320 of the installed shelf 300. The shelf portion 200 is positioned on the −X side of the installed shelf 300.

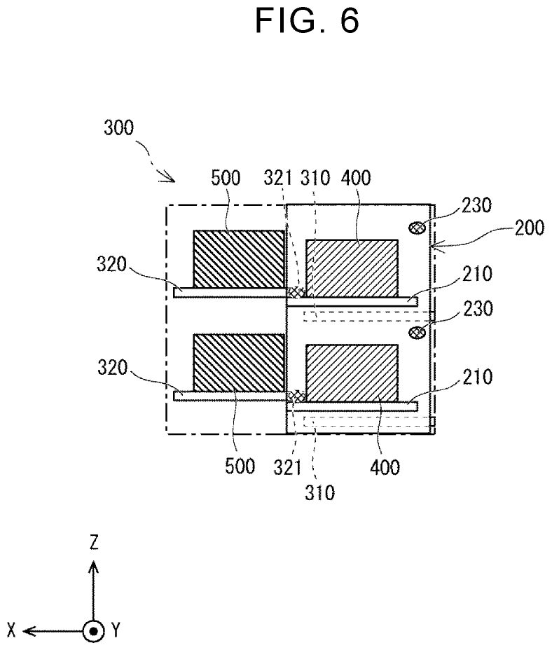

When the transport robot 100 moves to the +X side in the configuration shown in FIG. 5, the configuration changes to a configuration shown in FIG. 6. In FIG. 6, the rack 210 is present directly above the first rack 310. In the X direction, the position of the rack 210 substantially agrees with the position of the first rack 310. The abutment portion 321 abuts on the package 400. That is, the side face of the package 400 on the +X side and the abutment portion 321 are in contact with each other. Since the movement of the package 400 in the +X direction is restricted, the package 400 does not move together with the transport robot 100.

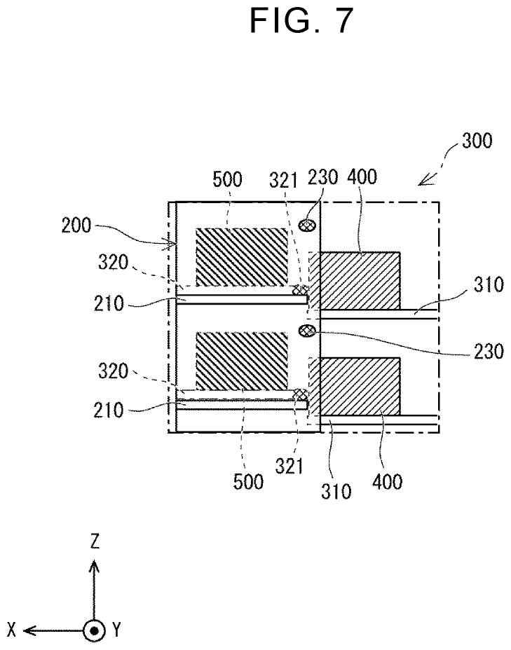

When the transport robot 100 moves to the +X side in the configuration shown in FIG. 6, the configuration changes to a configuration shown in FIG. 7. In FIG. 7, the second rack 320 is present directly above the rack 210. In the X direction, the position of the rack 210 substantially agrees with the position of the second rack 320. Since the rack 210 has passed directly above the first rack 310, the rack 210 is located on the +X side of the first rack 310. The abutment portion 321 pushes the package 400 from the rack 210. The package 400 falls from the rack 210 onto the first rack 310. By the movement of the transport robot 100, the package 400 is transferred from the rack 210 onto the first rack 310. Since the abutment portion 321 abuts on the package 400, the package 400 can be prevented from falling off the first rack 310.

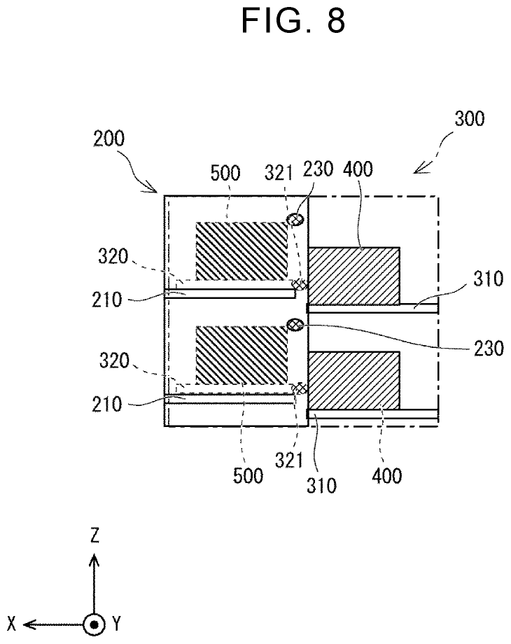

When the transport robot 100 moves to the +X side in the configuration shown in FIG. 7, the configuration changes to a configuration shown in FIG. 8. In FIG. 8, the second rack 320 is present directly above the rack 210. The abutment portion 230 abuts on the package 500. That is, the side face of the package 500 on the −X side and the abutment portion 230 are in contact with each other. Thus, the package 500 moves in the +X direction along with the movement of the transport robot 100.

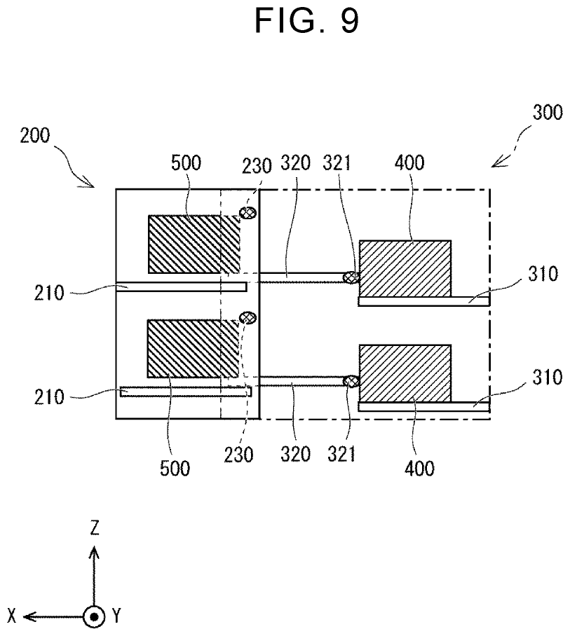

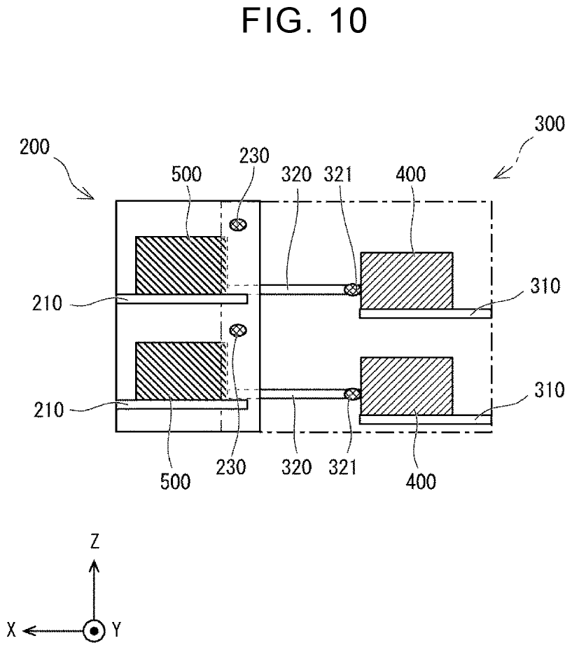

When the transport robot 100 moves to the +X side in the configuration shown in FIG. 8, the configuration changes to a configuration shown in FIG. 9. Since the rack 210 has passed directly below the second rack 320 in FIG. 9, the rack 210 is located on the +X side of the second rack 320. Since the abutment portion 230 abuts on the package 500, the abutment portion 230 pushes the package 500 from the second rack 320 in the +X direction. As shown in FIG. 10, the package 500 falls onto the rack 210. By the movement of the transport robot 100, the package 500 is transferred from the second rack 320 onto the rack 210.

Accordingly, the transfer of the package 400 and the transfer of the package 500 are completed. The transport robot 100 passes through the installed shelf 300 to transfer the package 400 on the rack 210 onto the first rack 310 and transfer the package 500 on the second rack 320 onto the rack 210. That is, the packages 400, 500 can be passed between the shelf portion 200 and the installed shelf 300 by the movement of the transport robot 100. There is no need for an arm mechanism or the like for transferring the packages. Accordingly, the packages 400, 500 can be transferred with a simple configuration. Thus, the passing operation can be performed efficiently.

Before the transfer, the abutment portion 230 is located on the −X side of the package 400 as shown in FIG. 5. The abutment portion 321 is located on the −X side of the package 500. Thus, the abutment portion 230 abuts on the package 500 after the abutment portion 321 abuts on the package 400. That is, the abutment portion 230 abuts on the package 500 after the package 400 is placed on the first rack 310. After the package 400 is pushed onto the first rack 310, the package 500 is pushed onto the rack 210. The abutment portion 230 is installed at the position higher than that of the transport target object and at the same height as that of the package 500. Thus, the passing mechanism can appropriately transfer the package.

For example, the package 400 may be an empty container and the package 500 may be a container that contains used equipment or a specimen. When the passing of the package 400 is completed, the empty container is placed on the installed shelf 300 and the container that contains equipment or the like is placed on the shelf portion 200. The transport robot 100 transports the container that contains equipment or the like to a necessary user or transport destination. When the user loads equipment or the like into the empty container, the transport robot 100 passes the container again. Thus, the equipment or the like can be transported efficiently.

The abutment portion 230 and the abutment portion 321 may include an elastic body or a flexible body. Thus, energy at the time of abutment can be absorbed. For example, the abutment portion 230 and the abutment portion 321 may be made of an elastic material such as rubber or resin. The abutment portion 230 and the abutment portion 321 may be hooks for hooking packages.

Although the abutment portion 230 has been described as abutting on the package 500, the abutment portion 230 may abut on an object other than the package 500. For example, the abutment portion 230 may abut on a mechanism on the installed shelf side to push out the package 500. That is, the abutment portion 230 may push the package 500 with the mechanism on the installed shelf side interposed between the abutment portion 230 and the package 500.

Similarly, the abutment portion 321 may abut on an object other than the package 400. For example, the abutment portion 321 may abut on a mechanism on the transport robot 100 side to restrict the movement of the package 400. That is, the abutment portion 321 may push the package 400 with the mechanism on the transport robot 100 side interposed between the abutment portion 321 and the package 400.

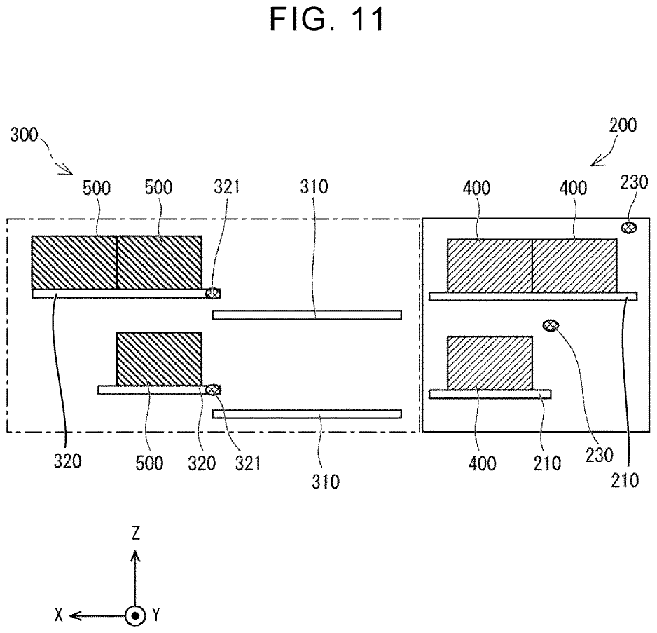

Although description has been made about the configuration in which one package is placed on each of the rack 210, the first rack 310, and the second rack 320, a plurality of packages may be placed. For example, two packages 400 may be placed on the rack 210 as shown in FIG. 11. The two packages 400 are placed side by side in the X direction. Similarly, two packages 500 may be placed on the second rack 320. The two packages 500 are placed side by side in the X direction. Thus, it is possible to increase the number of packages that can be transferred at a time. The packages 400, 500 may be placed side by side in the Y direction or the Z direction.

### Second Embodiment

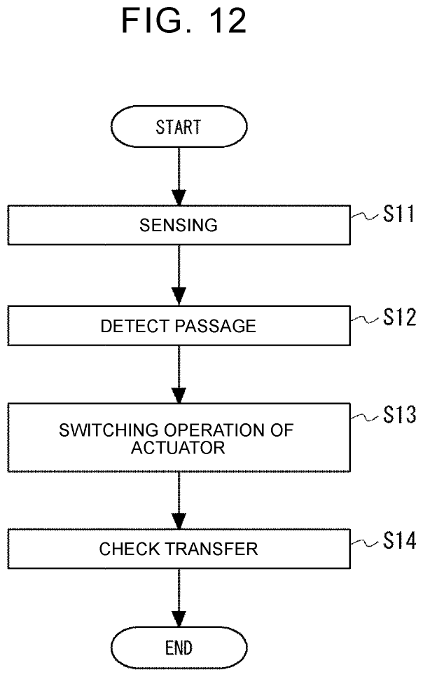

In a second embodiment, the passing mechanism includes an actuator for transferring a package. The actuator can be a magnet for magnetically attracting the package. The actuator switches ON and OFF of the magnetic attraction in response to the passage of the transport robot 100. The passing mechanism may further include a sensor for detecting a package. The actuator performs the switching operation based on a detection result from the sensor. First, a transfer method according to the second embodiment will be described with reference to FIG. 12. FIG. 12 is a flowchart showing a passing operation.

First, the sensor senses a package (S11). Next, the sensor detects passage of the package (S12). Then, the actuator performs the switching operation (S13). For example, the actuator includes a magnet that magnetically attracts the package. The actuator switches ON and OFF of the magnetic attraction based on the detection result from the sensor. The package 400, 500 can be transferred by magnetically attracting the package with the magnet of the actuator. A sensor or the like checks the transfer (S14). For example, a sensor of the transport robot 100 detects that the package 500 has been received.

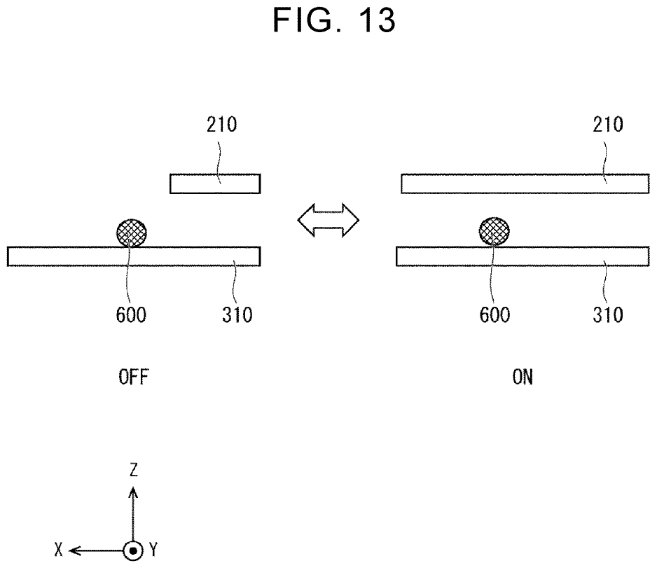

FIGS. 13 to 15 are schematic diagrams showing examples of the sensor. In FIG. 13, a sensor 600 is attached to the first rack 310. The sensor 600 is an optical sensor and includes a light-emitting portion, a light-receiving portion, and the like. The light-emitting portion includes a light source or the like that emits light upward. The light-receiving portion includes a photodiode or the like that detects light from above.

When the rack 210 is not present directly above the sensor 600, the light from the light source is not reflected by the rack 210. When the rack 210 is present directly above the sensor 600, the light from the light source is reflected by the rack 210. In this case, the photodiode detects the light reflected by the rack 210. Therefore, the detection result from the light-receiving portion changes depending on whether the rack 210 is present directly above the sensor 600. The sensor 600 can detect that the rack 210 is present directly above the sensor 600.

When the rack 210 is present directly above the sensor 600, the passage of the transport robot 100 is detected. Therefore, the sensor 600 turns ON a passage switch. When the rack 210 is not present directly above the sensor 600, the passage of the transport robot 100 is not detected. Therefore, the sensor 600 turns OFF the passage switch. The attachment position of the sensor 600 is not limited to the position below the rack 210. For example, the sensor 600 may be attached lateral to or above the rack 210 or the package 400.

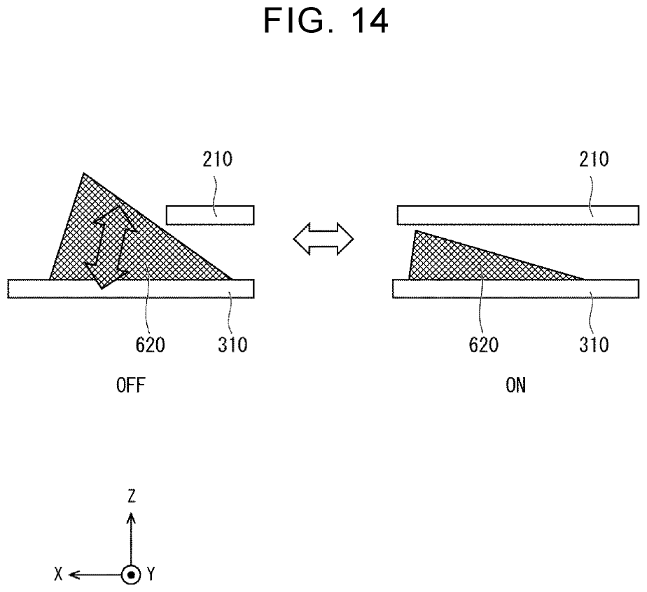

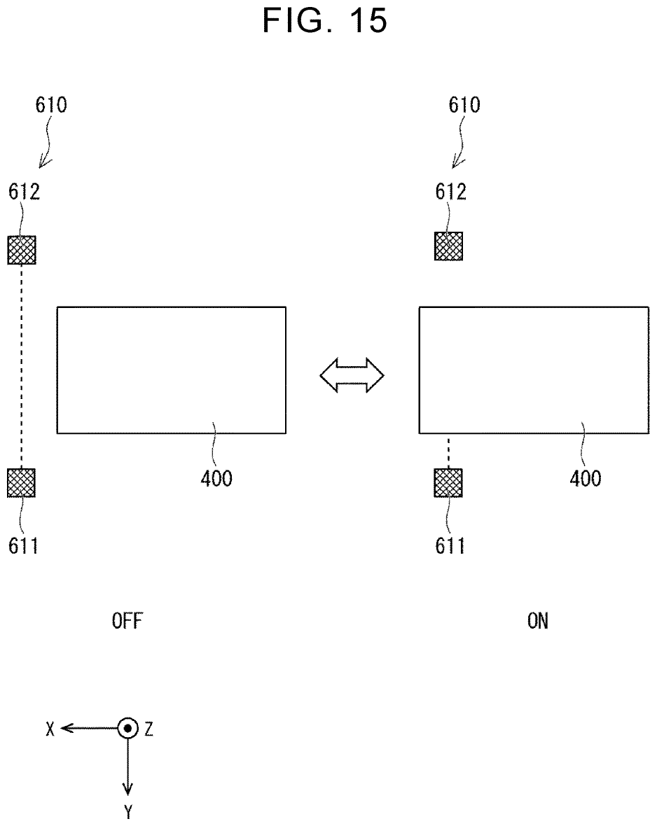

In FIG. 14, a sensor 620 is attached to the first rack 310. The sensor 620 is a mechanical switch. For example, the sensor 620 has a wedge shape and includes an elastic body such as a spring. When the rack 210 is not present directly above the sensor 620, the sensor 620 is not in contact with the rack 210. When the rack 210 is present directly above the sensor 620, the sensor 620 is in contact with the rack 210. Therefore, an urging force is applied to urge the sensor 620 downward and the sensor 620 is deformed. Thus, it is possible to detect that the rack 210 is present directly above the sensor 620.

When the rack 210 is present directly above the sensor 620, the passage of the transport robot 100 is detected. Therefore, the sensor 620 turns ON the passage switch. When the rack 210 is not present directly above the sensor 620, the passage of the transport robot 100 is not detected. Therefore, the sensor 620 turns OFF the passage switch. The attachment position of the sensor 620 is not limited to the position below the rack 210. For example, the sensor 620 may be attached lateral to or above the rack 210 or the package 400.

In FIG. 15, a sensor 610 is an optical entry sensor. The sensor 610 includes a light-emitting portion 611 and a light-receiving portion 612. The sensor 610 is installed at a height at which the package 400 passes. For example, the sensor 610 is attached to the first rack 310 (not shown in FIG. 15).

The light-emitting portion 611 emits light such as infrared rays toward the light-receiving portion 612. When the package 400 reaches the position of the sensor 610, the light from the light-emitting portion 611 is blocked. That is, when the package 400 is present between the light-emitting portion 611 and the light-receiving portion 612, the light from the light-emitting portion 611 does not enter the light-receiving portion 612. When the package 400 is not present between the light-emitting portion 611 and the light-receiving portion 612, the light from the light-emitting portion 611 enters the light-receiving portion 612. Thus, the sensor 610 can detect the passage of the package 400. The sensor 610 can detect the passage of the package 400 based on a detection result from the light-receiving portion 612.

When the package 400 is present between the light-emitting portion 611 and the light-receiving portion 612, the passage of the package 400 is detected. Therefore, the sensor 610 turns ON the passage switch. When the package 400 is not present between the light-emitting portion 611 and the light-receiving portion 612, the passage of the transport robot 100 is not detected. Therefore, the sensor 610 turns OFF the passage switch.

The sensor is not limited to those in the configurations shown in FIGS. 13 to 15. For example, a camera or a lidar sensor provided on the transport robot 100 may be used as a passage sensor. A sensor provided around the installed shelf 300 may detect the passage of the transport robot 100.

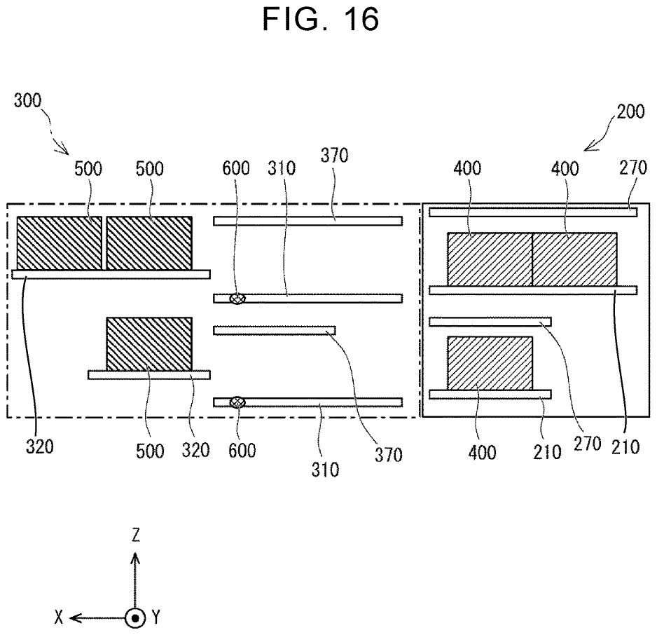

The passing operation by the passing mechanism will be described with reference to FIGS. 16 to 19. FIGS. 16 to 19 are side views illustrating steps of the passing operation. FIGS. 16 to 19 simply show a part of the configuration shown in FIGS. 1 to 4. For example, the transport robot 100 is omitted. Although the sensor 600 is provided in FIGS. 16 to 19, the sensor 610, the sensor 620, or the like may be used instead of the sensor 600.

In the present embodiment, the sensor 600 is provided on the first rack 310. The installed shelf 300 includes an actuator 370. The shelf portion 200 includes an actuator 270. The actuators 270, 370 each include a magnet that magnetically attracts the packages 400, 500. The magnet may be an electromagnet or a permanent magnet.

In the case of an electromagnet, the actuator 370 controls a current to control ON and OFF of the magnetic attraction. In the case of a permanent magnet, a magnetic circuit disposed around the permanent magnet can be used as the actuator. By changing the angle and position of a yoke provided around the permanent magnet, the actuator can turn ON or OFF the magnetic attraction. At least a part of the package 400, 500 is made of a metal material that can be magnetically attracted.

FIG. 16 shows a configuration before the packages 400, 500 are transferred. That is, the package 400 is placed on the rack 210 of the shelf portion 200, and the package 500 is placed on the second rack 320 of the installed shelf 300. The shelf portion 200 is positioned on the −X side of the installed shelf 300.

As shown in FIG. 16, the actuator 270 is disposed above the rack 210. The actuator 370 is disposed above the first rack 310. The actuators 270, 370 each have a flat plate shape parallel to the XY plane. Before the transfer, the package 400 is located between the actuator 270 and the rack 210. The package 400 is located below the actuator 270 with a space therebetween. The actuator 270 is disposed at a position higher than those of the package 500 and the actuator 370. The actuator 370 is disposed at a height between the package 400 and the actuator 270. The actuator 370 is disposed on the +X side of the rack 210, the package 400, and the actuator 270. In the state shown in FIG. 16, the sensor 600 turns OFF the passage switch. Therefore, the magnetic attraction of the actuators 270, 370 is OFF.

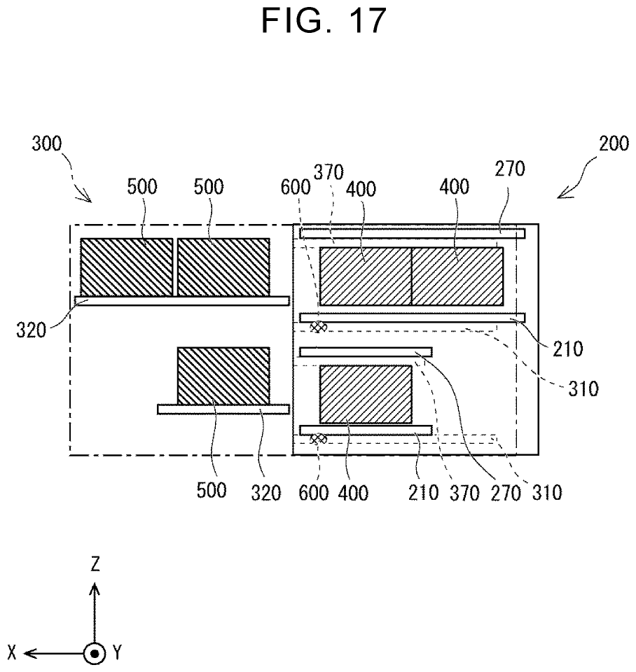

When the transport robot 100 moves to the +X side in the configuration shown in FIG. 16, the configuration changes to a configuration shown in FIG. 17. In FIG. 17, the rack 210 and the actuator 270 are present directly above the first rack 310. In the X direction, the positions of the rack 210 and the actuator 270 substantially agree with the positions of the first rack 310 and the actuator 370. Since the rack 210 is present directly above the sensor 600, the sensor 600 turns ON the passage switch. The actuator 370 switches ON the magnetic attraction. Therefore, the actuator 370 magnetically attracts the package 400. That is, the package 400 is lifted from the rack 210. Thus, the package 400 does not move together with the transport robot 100.

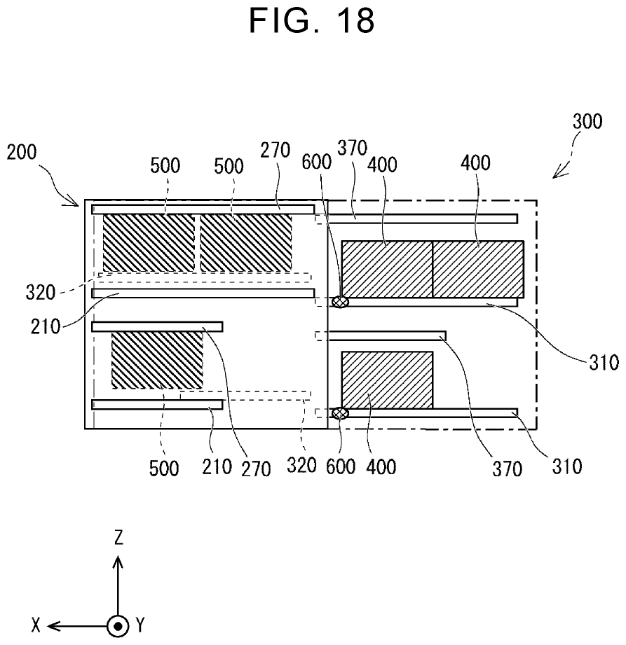

When the transport robot 100 moves to the +X side in the configuration shown in FIG. 17, the configuration changes to a configuration shown in FIG. 18. In FIG. 18, the second rack 320 is present directly above the rack 210. In the X direction, the positions of the rack 210, the second rack 320, and the actuator 270 agree with each other. Since the rack 210 has passed directly above the first rack 310, the rack 210 is located on the +X side of the first rack 310. The rack 210 is not located directly above the sensor 600. Therefore, the sensor 600 turns OFF the passage switch.

When the passage switch is switched from ON to OFF, the actuator 270 turns ON the magnetic attraction and the actuator 370 turns OFF the magnetic attraction. Since the actuator 370 turns OFF the magnetic attraction for the package 400, the package 400 falls onto the first rack 310. Since the actuator 270 turns ON the magnetic attraction, the package 500 is magnetically attracted. The package 500 is lifted from the second rack 320.

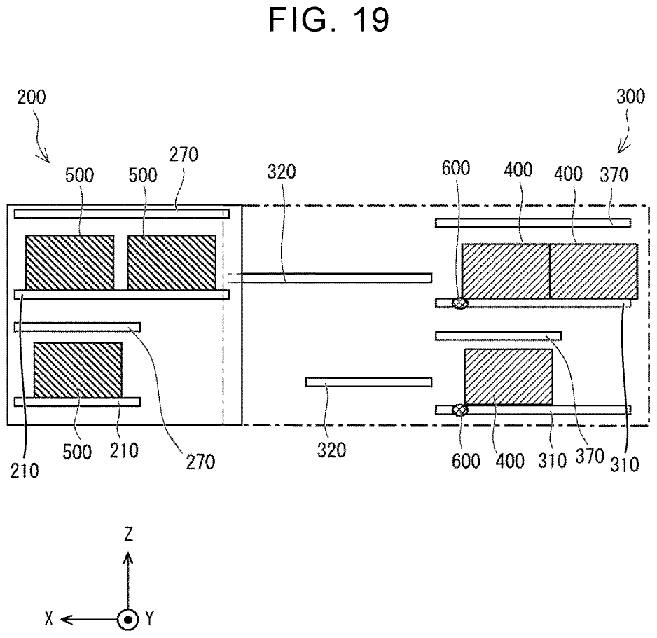

When the transport robot 100 moves to the +X side in the configuration shown in FIG. 18, the configuration changes to a configuration shown in FIG. 19. In FIG. 19, the rack 210 is located on the +X side of the second rack 320. In FIG. 19, the package 500 has fallen on the rack 210 because the magnetic attraction of the actuator 270 has been turned OFF. Thus, the package 500 is transferred to the shelf portion 200. After the second rack 320 has passed above the rack 210, the actuator 270 turns OFF the magnetic attraction. For example, the actuator 270 is turned OFF after a predetermined period has elapsed from the timing at which the passage switch is switched from ON to OFF. Thus, the package 500 is placed on the rack 210.

In this manner, the actuators 270, 370 control ON and OFF of the magnetic attraction based on the detection result from the sensor 600. That is, the actuators 270, 370 control the switching timings of the magnetic attraction based on the timing at which the sensor 600 detects the passage. For example, the actuators 270, 370 perform the operations of switching ON and OFF of the magnetic attraction by using a timer. After a predetermined period has elapsed from the timing at which the sensor 600 detects the passage, the magnetic attraction may be switched ON and OFF. Thus, the passing mechanism can pass the package 400 and the package 500. In the second embodiment, the abutment portion 230 and the abutment portion 321 are not necessary.

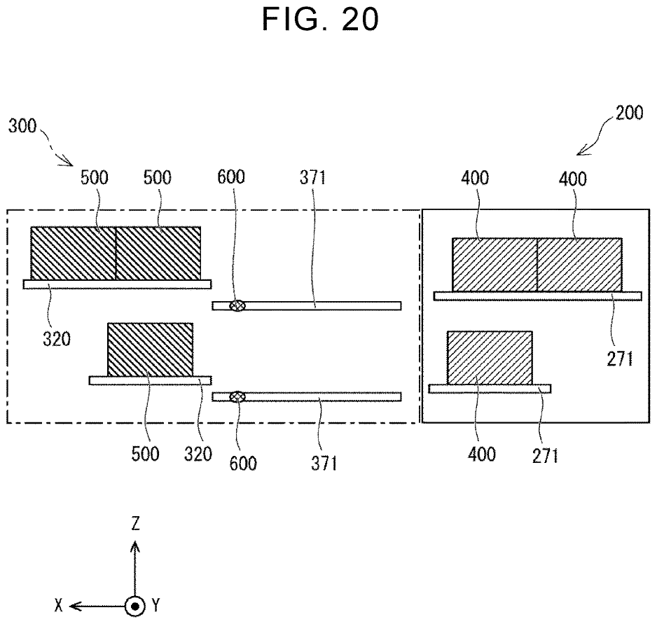

Third Embodiment In a third embodiment, the actuators function as racks (stages) that support the packages 400, 500. That is, the actuators each have a flat plate shape and are installed below the packages 400, 500. The package 400 and the package 500 are placed on the actuators The passing operation by the passing mechanism will be described with reference to FIGS. 20 to 23. FIGS. 20 to 23 are side views illustrating steps of the passing operation. FIGS. 20 to 23 simply show a part of the configuration shown in FIGS. 1 to 4. For example, the transport robot 100 is omitted.

As shown in FIG. 20, the installed shelf 300 includes an actuator 371. The actuator 371 is provided at the position of the first rack 310 of the first embodiment. The package 400 will be placed on the actuator 371. The shelf portion 200 includes an actuator 271. The actuator 271 is provided at the position of the rack 210 of the first embodiment. The package 400 is placed on the actuator 271. The actuator 271 is disposed at a position higher than that of the actuator 371. The actuator 271 is disposed at a position lower than that of the second rack 320. Therefore, the actuator 271 passes between the second rack 320 and the actuator 371.

The actuators 371, 271 include magnetic circuits or electromagnets. The upper faces of the actuators 271, 371 may be subjected to low-friction treatment to reduce frictional forces. Alternatively, the actuators 271, 371 may include rollers or the like to reduce the frictional forces. Thus, the package 400 can slide along the actuator 271. Similarly, the package 400 can slide along the actuator 371.

FIG. 20 shows a configuration before the packages 400, 500 are transferred. That is, the package 400 is placed on the actuator 271 of the shelf portion 200, and the package 500 is placed on the second rack 320 of the installed shelf 300. The shelf portion 200 is positioned on the −X side of the installed shelf 300. In the state shown in FIG. 20, the sensor 600 turns OFF the passage switch. Therefore, the magnetic attraction of the actuators 271 and 371 is OFF.

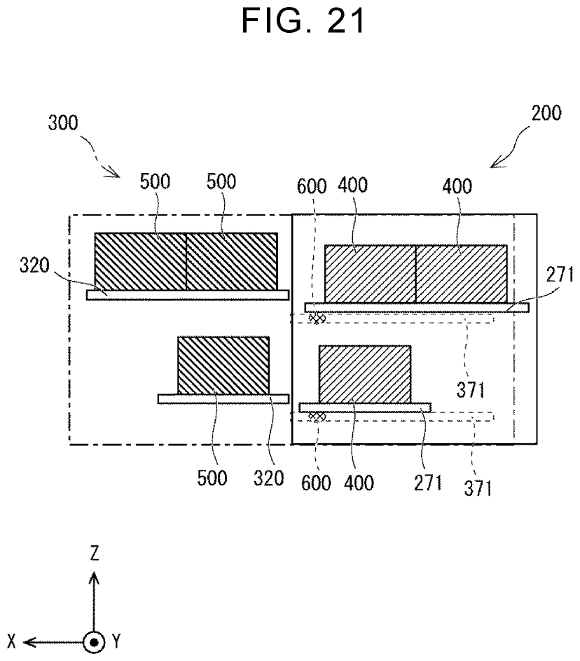

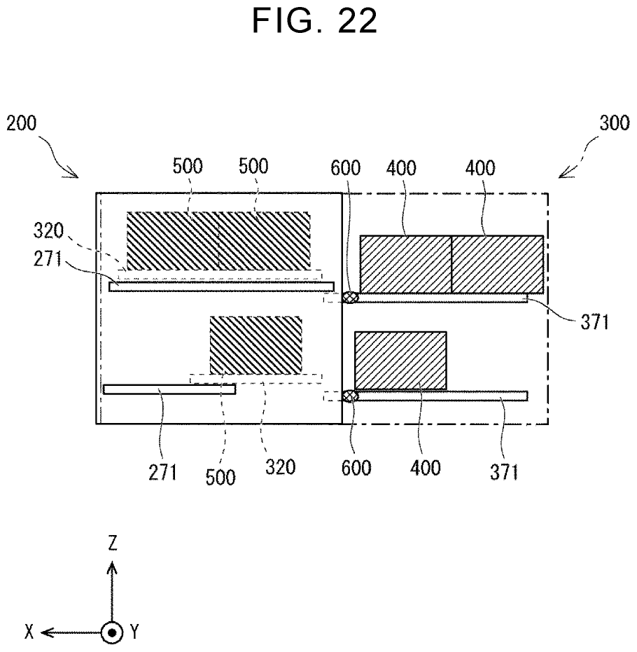

When the transport robot 100 moves to the +X side in the configuration shown in FIG. 20, the configuration changes to a configuration shown in FIG. 21. In FIG. 21, the actuator 271 is present directly above the actuator 371. In the X direction, the position of the actuator 271 substantially agrees with the position of the actuator 371. Since the actuator 271 is present directly above the sensor 600, the sensor 600 turns ON the passage switch. The actuator 371 switches ON the magnetic attraction. Therefore, the actuator 371 magnetically attracts the package 400. The actuator 271 turns OFF the magnetic attraction.

The actuator 371 magnetically attracts the package 400. Therefore, the package 400 slides along the actuator 271. Even when the actuator 271 moves in the +X direction, the package 400 does not move in the +X direction. By the magnetic attraction of the actuator 371, the package 400 does not move together with the transport robot 100.

When the transport robot 100 moves to the +X side in the configuration shown in FIG. 21, the configuration changes to a configuration shown in FIG. 22. In FIG. 22, the actuator 271 is present directly below the second rack 320. In the X direction, the position of the actuator 271 agrees with the position of the second rack 320. Since the actuator 271 has passed directly above the actuator 371, the actuator 271 is located on the +X side of the actuator 371. The actuator 271 is not located directly above the sensor 600. Therefore, the sensor 600 turns OFF the passage switch.

When the passage switch is switched from ON to OFF, the actuator 371 turns OFF the magnetic attraction. The package 400 is transferred onto the actuator 371. When the passage switch is switched from ON to OFF, the actuator 271 turns ON the magnetic attraction. Therefore, the actuator 271 magnetically attracts the package 500.

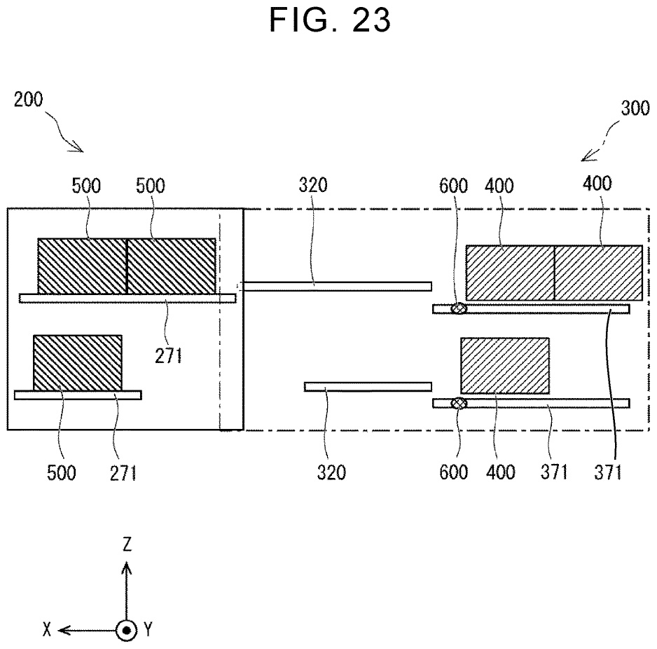

The package 500 slides along the second rack 320. Therefore, the package 500 moves together with the transport robot 100. When the actuator 271 passes below the second rack 320, the package 500 is transferred onto the actuator 271 as shown in FIG. 23.

For example, the actuator 271 turns OFF the magnetic attraction after a predetermined period has elapsed from the timing at which the passage switch is switched from ON to OFF. The actuator 271 turns OFF the magnetic attraction after the package 500 is placed on the actuator 271. Thus, the package 500 is transferred to the shelf portion 200.

In this manner, the actuators 271, 371 control ON and OFF of the magnetic attraction based on the detection result from the sensor 600. That is, the actuators control the switching timings of the magnetic attraction based on the timing at which the sensor 600 detects the passage. For example, the actuator 271 or the actuator 371 may switch ON and OFF of the magnetic attraction by using a timer. For example, after a predetermined period has elapsed from the timing at which the sensor 600 detects the passage, the magnetic attraction may be switched ON and OFF. Thus, the passing mechanism can pass the package 400 and the package 500. In the third embodiment, the abutment portion 230 and the abutment portion 321 are not necessary.

### Fourth Embodiment

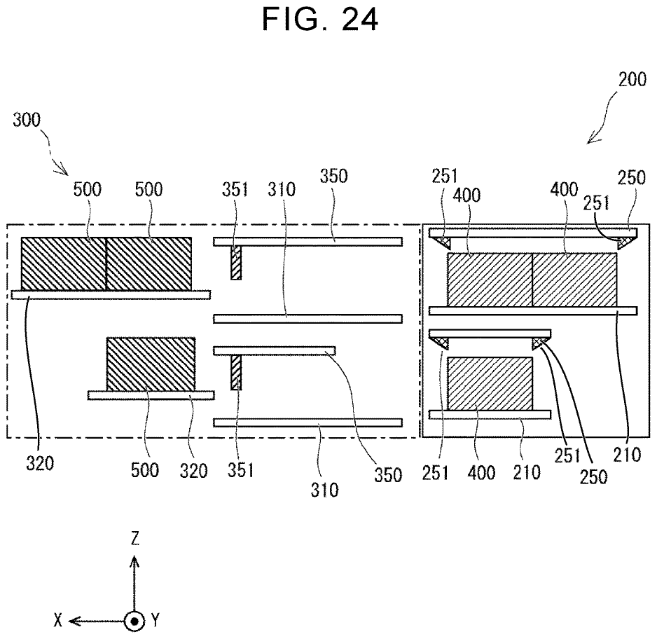

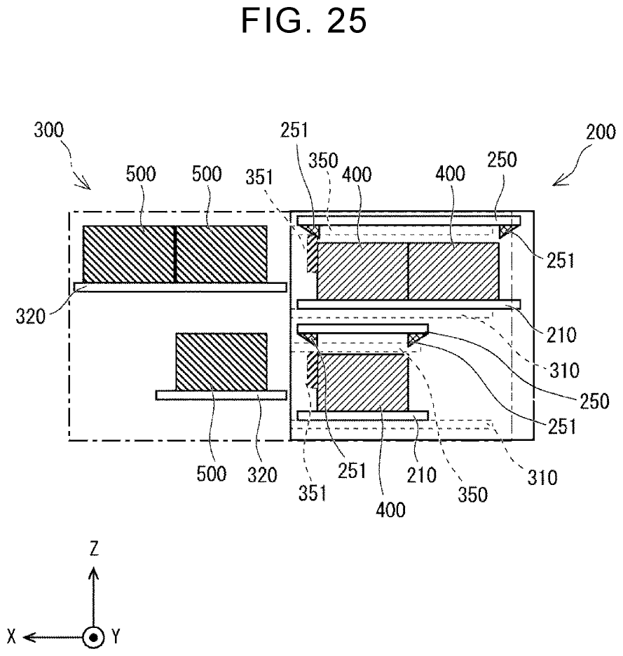

A passing operation by a passing mechanism according to a fourth embodiment will be described. FIGS. 24 to 27 are side views illustrating steps of the passing operation. FIGS. 24 to 27 simply show a part of the configuration shown in FIGS. 1 to 4. For example, the transport robot 100 is omitted. In the present embodiment, the actuators and the sensor are not necessary.

In the present embodiment, the shelf portion 200 includes an upper plate 250 and wall portions 251 as shown in FIG. 24. In the shelf portion 200, the upper plate 250 and the wall portions 251 are provided instead of the abutment portion 230 of the first embodiment. The installed shelf 300 includes an upper plate 350 and a wall portion 351. In the installed shelf 300, the upper plate 350 and the wall portion 351 are provided instead of the abutment portion 321 of the first embodiment.

The upper plate 350 is disposed above the first rack 310. The upper plate 350 is a flat plate parallel to the XY plane. The upper plate 350 is positioned higher than the package 400. The wall portion 351 is provided on the lower face of the upper plate 350. The wall portion 351 protrudes downward from the upper plate 350. The wall portion 351 may include a projection or a hook for hooking and holding the package 400. The wall portion 351 may include an elastic body such as a spring. Thus, the wall portion 351 can securely hold the package 400.

The upper plate 250 is disposed above the rack 210. The upper plate 250 is a flat plate parallel to the XY plane. The upper plate 250 is positioned higher than the package 500. Before the transfer, the package 400 is positioned between the upper plate 250 and the rack 210.

The wall portions 251 are provided on the lower face of the upper plate 250. The wall portions 251 protrude downward from the upper plate 250. The wall portions 251 are attached to both ends of the upper plate 250 in the X direction. The wall portion 251 has a wedge shape to lock the package 500. The wall portion 251 may each include a projection or a hook for hooking and holding the package 500. The wall portion 251 may include an elastic body such as a spring. Thus, the wall portion 251 can securely hold the package 500.

The two wall portions 251 are opened and closed in conjunction with each other to hold the package 500. For example, when the package 500 is present directly below the wall portions 251, the wall portions 251 are pushed upward by the package 500. Thus, the two wall portions 251 are opened. When the package 500 is not present directly below the wall portions 251, the wall portions 251 are not pushed upward by the package 500. Thus, the wall portions 251 are closed. That is, the two wall portions 251 serve as a switch mechanism in which the wall portions 251 operate in conjunction with each other.

The operation of the wall portions 251 will be described with reference to FIG. 28. FIG. 28 illustrates an operation for opening and closing the wall portions 251. As the transport robot 100 moves, the wall portions 251 perform the opening and closing operation in the order of ST1, ST2, ST3, and ST4. Before the wall portions 251 come into contact with the package 500 as in ST1, the wall portions 251 are closed. ST1 corresponds to the configuration shown in FIG. 24.

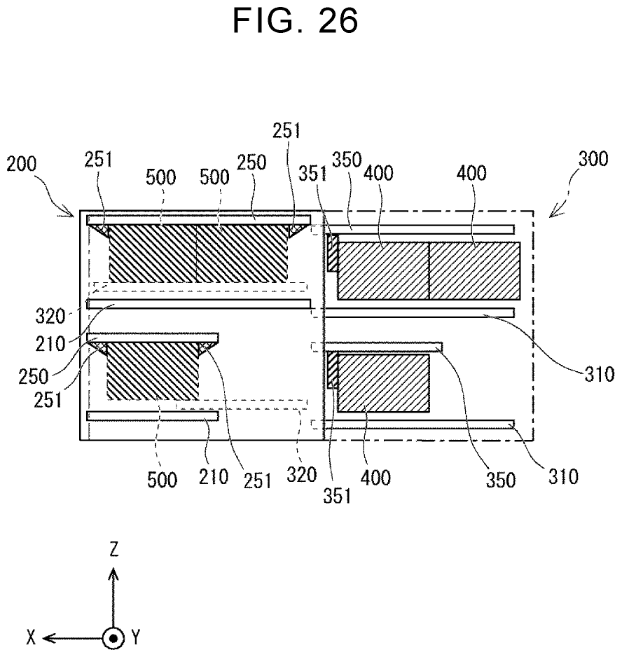

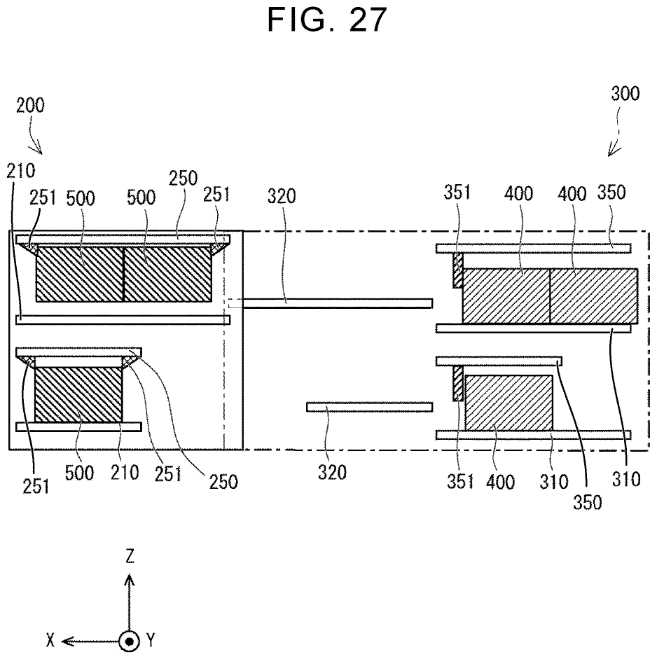

When the transport robot 100 moves in the state of ST1, the state changes to that of ST2. In ST2, the package 500 is present directly below the wall portion 251 on the +X side. When the package 500 is present directly below the wall portion 251, the wall portion 251 comes into contact with the package 500. Therefore, the wall portion 251 is pushed upward by the package 500, and the two wall portions 251 are opened. For example, when the wall portion 251 includes an elastic body such as a spring, the elastic body is urged and deformed. In the open state, the wall portion 251 may be crushed and deformed. ST2 corresponds to a timing between FIG. 25 and a time before FIG. 26.

When the transport robot 100 moves, the state changes to that of ST3. In ST3, the packages 500 are present between the two wall portions 251. In this case, the two wall portions 251 are not pushed upward by the packages 500 and are therefore closed. Thus, the two wall portions 251 can lock the packages 500. That is, the packages 500 are held while being sandwiched between the two wall portions 251. ST3 corresponds to the configuration shown in FIG. 26.

When the transport robot 100 further moves, the state changes to that of ST4. In ST4, the packages 500 are moved from the second rack 320. Even in such a state, the pair of wall portions 251 engages with the packages 500 from both sides. Thus, the wall portions 251 can securely hold the packages 500.

The description returns to that in FIG. 24. FIG. 24 shows a configuration before the packages 400, 500 are transferred. That is, the package 400 is placed on the rack 210 of the shelf portion 200, and the package 500 is placed on the second rack 320 of the installed shelf 300. The shelf portion 200 is positioned on the −X side of the installed shelf 300.

When the transport robot 100 moves to the +X side in the configuration shown in FIG. 24, the configuration changes to a configuration shown in FIG. 25. In FIG. 25, the upper plate 350 is positioned directly above the rack 210 and the package 400. In the X direction, the position of the upper plate 350 substantially agrees with the position of the rack 210. The wall portion 351 abuts on and holds the package 400. Thus, the movement of the package 400 is restricted. The wall portion 351 may have a hook shape for hooking and holding the package 400.

When the transport robot 100 moves to the +X side in the configuration shown in FIG. 25, the configuration changes to a configuration shown in FIG. 26. In FIG. 26, the upper plate 250 is positioned above the package 500 and the rack 210. In the X direction, the position of the upper plate 250 substantially agrees with the position of the second rack 320. The wall portions 251 abut on and hold the package 500. Since the wall portions 251 are closed, the package 500 is hooked and held. Thus, the package 500 is transferred to the shelf portion 200. The package 500 moves together with the transport robot 100.

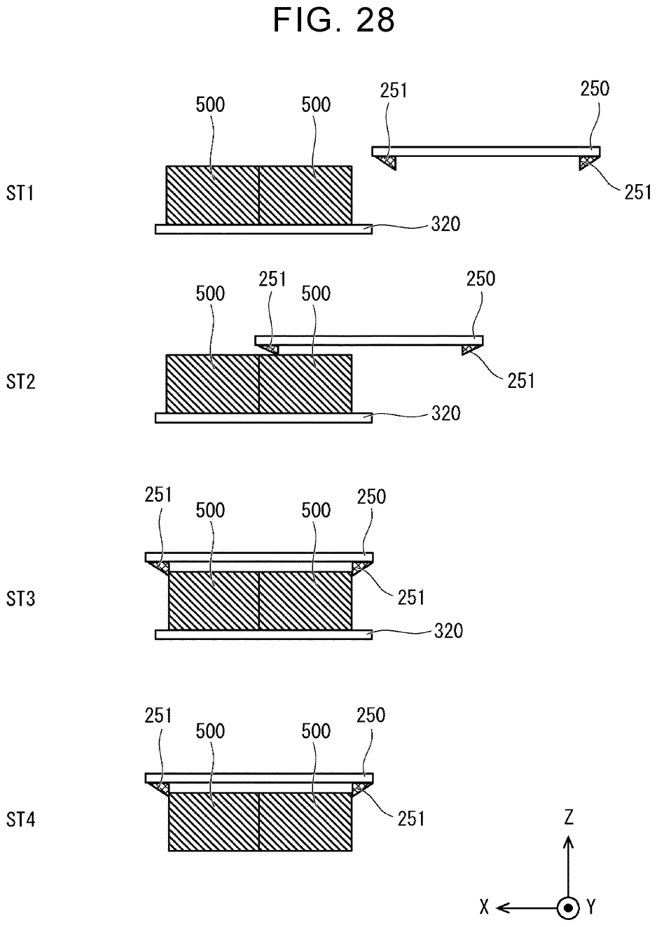

When the transport robot 100 moves to the +X side in the configuration shown in FIG. 26, the configuration changes to a configuration shown in FIG. 27. In FIG. 27, the rack 210 is positioned on the +X side of the second rack 320. In FIG. 27, the package 500 is transferred to the shelf portion 200. The package 500 is lifted from the rack 210.

Accordingly, the transfer of the package 400 and the package 500 is completed. That is, the package 400 is transferred from the shelf portion 200 to the installed shelf 300 and the package 500 is transferred from the installed shelf 300 to the shelf portion 200. In the present embodiment, the sensor and the actuators are not necessary.

### Fifth Embodiment

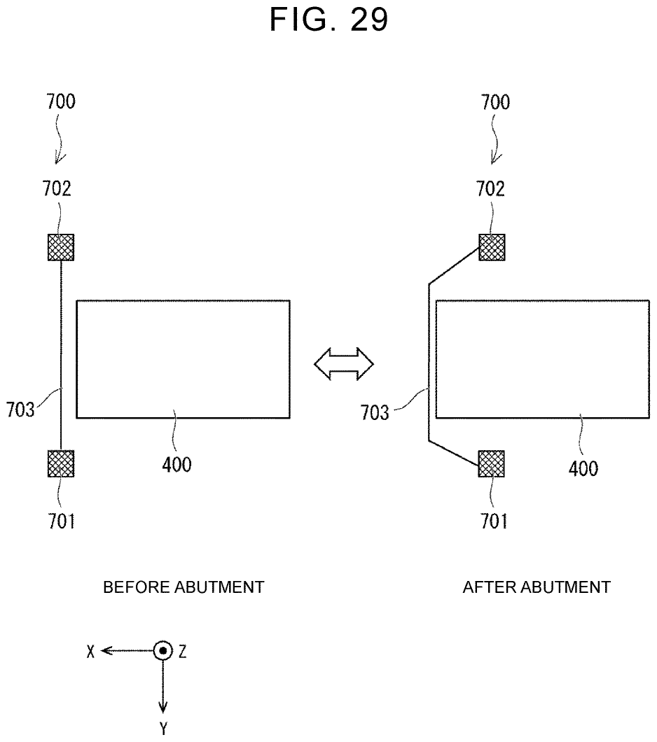

In a fifth embodiment, the abutment portion includes a shock absorbing member that absorbs a shock at the time of abutment. An abutment portion 700 including the shock absorbing member will be described with reference to FIG. 29. Although the abutment portion 700 is described as abutting on the package 400, the same configuration can be adopted for the package 500 as well. In other words, the abutment portion 700 can be replaced with at least one of the abutment portion 230 and the abutment portion 321 of the first embodiment.

The abutment portion 700 includes an attachment portion 701, an attachment portion 702, and a flexible body 703. The flexible body 703 is a cord-shaped or band-shaped member and serves as the shock absorbing member that absorbs a shock. One end of the flexible body 703 is attached to the attachment portion 701 and the other end is attached to the attachment portion 702. The attachment portion 701 is disposed on the +Y side of the package 400 and the attachment portion 702 is disposed on the −Y side of the package 400. At least one of the attachment portion 701 and the attachment portion 702 includes a reel around which the flexible body 703 is wound. The flexible body 703 is linearly disposed from the attachment portion 701 to the attachment portion 702 before abutment.

When the package 400 abuts on the flexible body 703, the flexible body 703 is deformed. Thus, the shock at the time of abutment is absorbed. For example, the flexible body 703 wound around the attachment portion 701 is unwound and extended. Therefore, the shock to be received by the package 400 can be reduced.

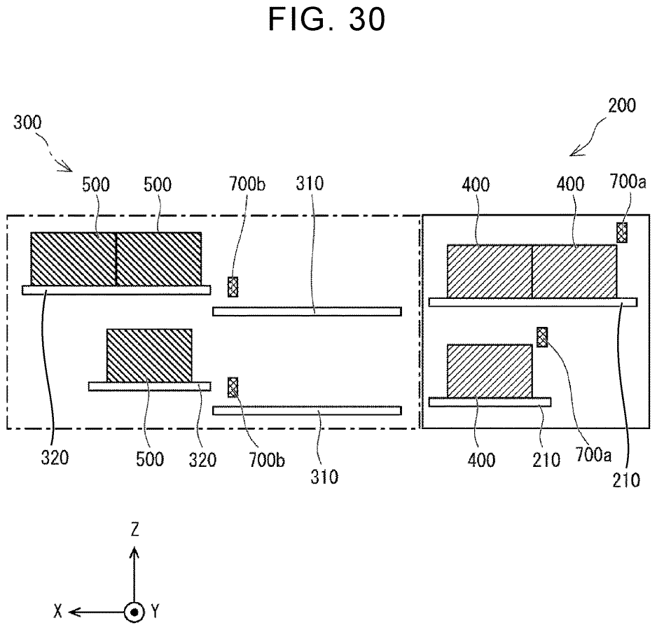

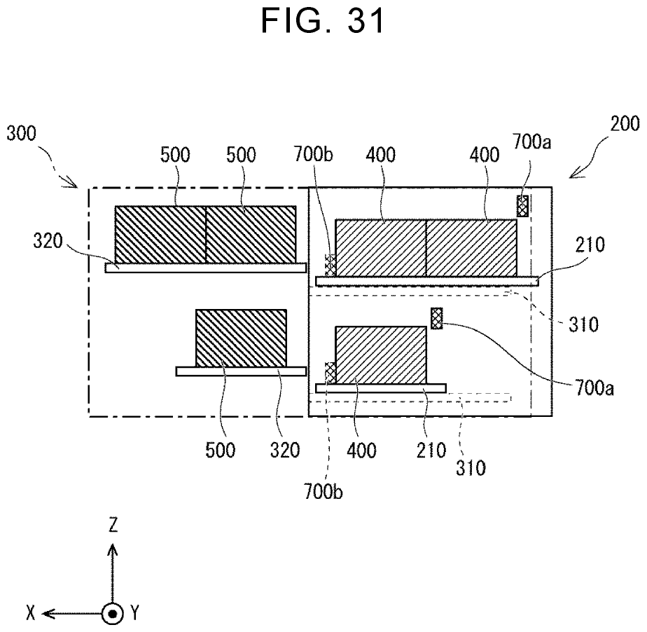

A passing operation by a passing mechanism using the abutment portion 700 will be described with reference to FIGS. 30 to 33. The shelf portion 200 includes an abutment portion 700a. The installed shelf 300 includes an abutment portion 700b. The abutment portion 700a of the shelf portion 200 is provided at the same height as that of the package 500. The abutment portion 700b of the installed shelf 300 is provided at the same height as that of the package 400. The abutment portion 700a of the shelf portion 200 is provided at a position higher than that of the package 400. The abutment portion 700a and the abutment portion 700b have the same configuration as that of the abutment portion 700 in FIG. 29.

FIG. 30 shows a configuration before the packages 400, 500 are transferred. That is, the package 400 is placed on the rack 210 of the shelf portion 200, and the package 500 is placed on the second rack 320 of the installed shelf 300. The shelf portion 200 is positioned on the −X side of the installed shelf 300.

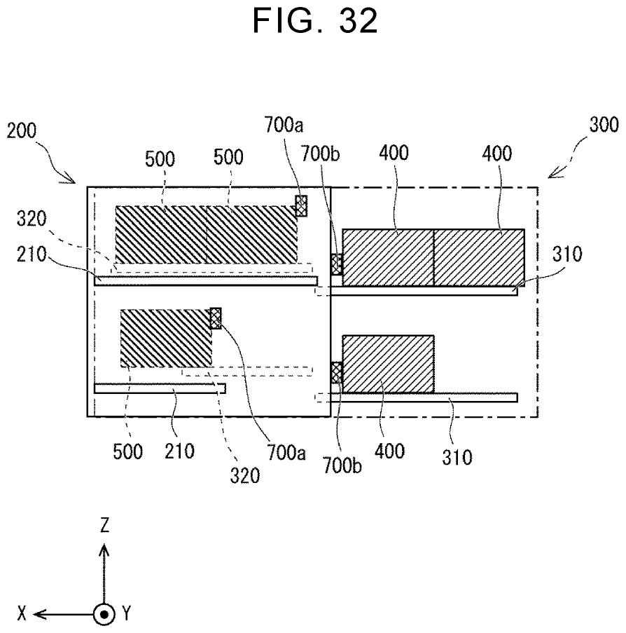

When the transport robot 100 moves to the +X side in the configuration shown in FIG. 30, the configuration changes to a configuration shown in FIG. 31. In FIG. 31, the package 400 abuts on the abutment portion 700b. Thus, the movement of the package 400 is restricted. The abutment portion 700b absorbs a shock at the time of abutment. Therefore, the shock on the package 400 can be reduced.

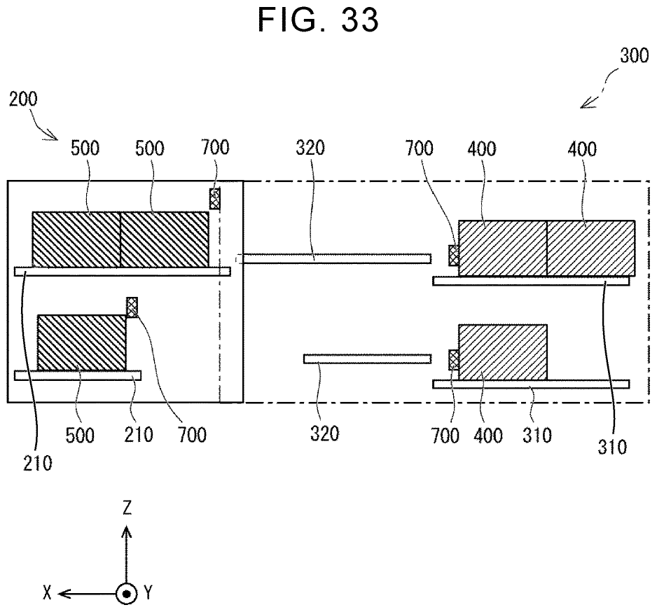

When the transport robot 100 moves to the +X side in the configuration shown in FIG. 31, the configuration changes to a configuration shown in FIG. 32. In FIG. 32, the package 500 abuts on the abutment portion 700a. Thus, the package 500 moves in the +X direction along with the movement of the transport robot 100. The abutment portion 700a absorbs a shock at the time of abutment. Therefore, the shock on the package 500 can be reduced.

When the transport robot 100 moves to the +X side in the configuration shown in FIG. 32, the configuration changes to a configuration shown in FIG. 33. In FIG. 32, the package 500 is placed on the second rack 320. In FIG. 33, the package 500 is transferred to the shelf portion 200. Accordingly, the transfer of the package 400 and the package 500 is completed. That is, the package 400 is transferred from the shelf portion 200 to the installed shelf 300 and the package 500 is transferred from the installed shelf 300 to the shelf portion 200. In the present embodiment, the sensor 600 and the actuators are not necessary.

The first to fifth embodiments can be used in combination as appropriate. Although the transport robot 100 is described as the mobile body that moves the package 400, the mobile body may be a trolley or the like that moves when pushed by a person.

The present invention is not limited to the embodiments described above, and may be modified as appropriate without departing from the spirit.

1. A passing mechanism system comprising:
a transport robot; and
an installed shelf for placing a package;
the transport robot comprising a chassis and a stand, wherein the chassis houses a lift mechanism, and a shelf portion is attached to the chassis,
the shelf portion serving as a mobile body-side stage for placing the package, wherein:
the shelf portion is configured to pass through the installed shelf such that the package is passed between the installed shelf and the shelf portion,
the installed shelf includes a first stage and a second stage having a height different from a height of the first stage, and
the shelf portion is configured to pass through the installed shelf such that a first package on the first stage is passed to the mobile body-side stage and a second package on the mobile body-side stage is passed to the second stage.

2. (canceled)

3. (canceled)

4. The passing mechanism system according to claim 1, wherein:
the installed shelf includes a first abutment portion configured to abut on a mechanism in the transport robot when the transport robot moves; and
the transport robot includes a second abutment portion configured to abut on a mechanism in the installed shelf when the transport robot moves.

5. The passing mechanism system according to claim 4, wherein:
the second abutment portion is configured to push the first package on the first stage in a moving direction of the transport robot such that the first package is passed to the mobile body-side stage; and
the first abutment portion is configured to push the second package on the mobile body-side stage in a direction opposite to the moving direction such that the second package is passed to the second stage.

6. The passing mechanism system according to claim 4, wherein the second abutment portion is provided at a position higher than a position of the second package and at a height of the first package.

7. The passing mechanism system according to claim 4, wherein at least one of the first abutment portion and the second abutment portion includes a locking member configured to lock the package.

8. The passing mechanism system according to claim 4, wherein at least one of the first abutment portion and the second abutment portion includes an elastic body configured to absorb energy at a time of abutment.

9. The passing mechanism system according to claim 4, wherein at least one of the first abutment portion and the second abutment portion includes a cord-shaped or band-shaped flexible body configured to absorb energy at a time of abutment.

10. The passing mechanism system according to claim 4, wherein at least one of the first abutment portion and the second abutment portion includes a hook configured to hook the package.

11. The passing mechanism system according to claim 3, wherein the mobile body-side stage is configured to pass at a height between the first stage and the second stage.

12. The passing mechanism system according to claim 11, wherein:
the first stage is installed at a position higher than a position of the second stage; and
a first abutment portion on the first stage is provided at a height of the second package.

13. The passing mechanism system according to claim 1, wherein:
at least one of the installed shelf and the mobile body-side stage includes a magnet configured to magnetically attract the package; and
a switching operation for switching ON and OFF of magnetic attraction of the magnet is performed when the shelf portion passes through the installed shelf.

14. The passing mechanism system according to claim 13, further comprising a sensor configured to detect passage of the shelf portion, wherein the switching operation is performed based on a detection result from the sensor.
